(19) United States
(12) Patent Application Publication
(10) Pub. No.: US 2008/0005384 A1
(43) Pub. Date: Jan. 3, 2008

(54) Hard disk drive progressive channel interface

(75) Inventors: John P. Mead, Longmont, CO (US); Lance Flake, Longmont, CO (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/444,584

(22) Filed: Jun. 1, 2006

(51) Int. Cl. G06F 13/28

(52) U.S. Cl. 710/22

(57) ABSTRACT

Hard disk drive progressive channel interface. A novel approach is presented by which the interface between a channel circuitry and a controller circuitry, such as those which can be implemented within a hard disk drive (HDD). Because of the location in which the disk management operations are supported and performed within the channel circuitry, the interface between the channel circuitry and the controller circuitry can be implemented to support direct memory access (DMA) protocol data transfers and control there between. Because the disk management operations are supported within the channel circuitry, as opposed to the controller circuitry, then the disk management operations need not necessarily comply with an interface between the channel circuitry and the controller circuitry. This allows for better control of the disk management operations as well as a much broader range and type of interface that can be employed for the interface between the two circuitries.

### CROSS REFERENCE TO RELATED PATENTS/PATENT APPLICATIONS

### Incorporation by Reference

The following U.S. Utility Patent Application is hereby incorporated herein by reference in its entirety and is made part of the present U.S. Utility Patent Application for all purposes:

1. U.S. Utility patent application Ser. No. ______, entitled “Disk controller, channel interface and methods for use therewith,” (Attorney Docket No. BP5369), filed concurrently on Thursday, Jun. 1, 2006 (Jun. 1, 2006), pending.

### BACKGROUND OF THE INVENTION

1. Technical Field of the Invention

The invention relates generally to hard disk drives (HDDs); and, more particularly, it relates to interfacing multiple circuitries within such HDDs.

2. Description of Related Art

As is known, many varieties of memory storage devices (e.g. disk drives or hard disk drives (HDDs)), such as magnetic disk drives are used to provide data storage for a host device, either directly, or through a network such as a storage area network (SAN) or network attached storage (NAS). Typical host devices include stand alone computer systems such as a desktop or laptop computer, enterprise storage devices such as servers, storage arrays such as a redundant array of independent disks (RAID) arrays, storage routers, storage switches and storage directors, and other consumer devices such as video game systems and digital video recorders. These devices provide high storage capacity in a cost effective manner.

Such an HDD includes a controller circuitry that is operable to interface with the host device to execute read and write commands of the host. This HDD controller generally includes one or more integrated circuits (ICs) that control the operation of the drive devices, such as servo motors and voice coil motors used to spin the disk and to control the position of one or more read/write heads, that generate timing signals and the produce and decode the signals required to write data to and read data from the disk. When two or more ICs are employed, an interface is required between these devices to facilitate the cooperation of these devices in the control of the disk drive. There is a continual need in the art for better means by which the interfacing of multi-ICs can be performed as applied within HDD systems.

### BRIEF SUMMARY OF THE INVENTION

The present invention is directed to apparatus and methods of operation that are further described in the following Brief Description of the Several Views of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 illustrates an embodiment of a disk drive unit.

FIG. 2 illustrates an embodiment of an apparatus that includes a disk controller.

FIG. 3, FIG. 4, FIG. 5, FIG. 6A, FIG. 6B, FIG. 7A, FIG. 7B, and FIG. 8 illustrate various embodiments of an apparatus that includes a channel interface.

FIG. 9A illustrates an embodiment of a handheld audio unit.

FIG. 9B illustrates an embodiment of a computer.

FIG. 9C illustrates an embodiment of a wireless communication device.

FIG. 9D illustrates an embodiment of a personal digital assistant (PDA).

FIG. 9E illustrates an embodiment of a laptop computer.

FIG. 10 illustrates an embodiment of a method for supporting an interface between multiple integrated circuits (ICs).

### DETAILED DESCRIPTION OF THE INVENTION

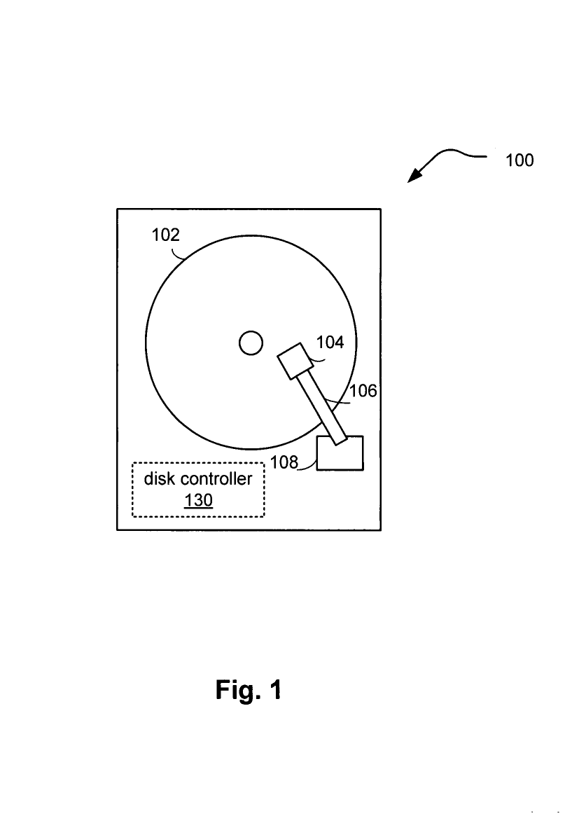

FIG. 1 illustrates an embodiment of a disk drive unit 100. In particular, disk drive unit 100 includes a disk 102 that is rotated by a servo motor (not specifically shown) at a velocity such as 3600 revolutions per minute (RPM), 4200 RPM, 4800 RPM, 5,400 RPM, 7,200 RPM, 10,000 RPM, 15,000 RPM, however, other velocities including greater or lesser velocities may likewise be used, depending on the particular application and implementation in a host device. In one possible embodiment, disk 102 can be a magnetic disk that stores information as magnetic field changes on some type of magnetic medium. The medium can be a rigid or non-rigid, removable or non-removable, that consists of or is coated with magnetic material.

Disk drive unit 100 further includes one or more read/write heads 104 that are coupled to arm 106 that is moved by actuator 108 over the surface of the disk 102 either by translation, rotation or both. A disk controller 130 is included for controlling the read and write operations to and from the drive, for controlling the speed of the servo motor and the motion of actuator 108, and for providing an interface to and from the host device.

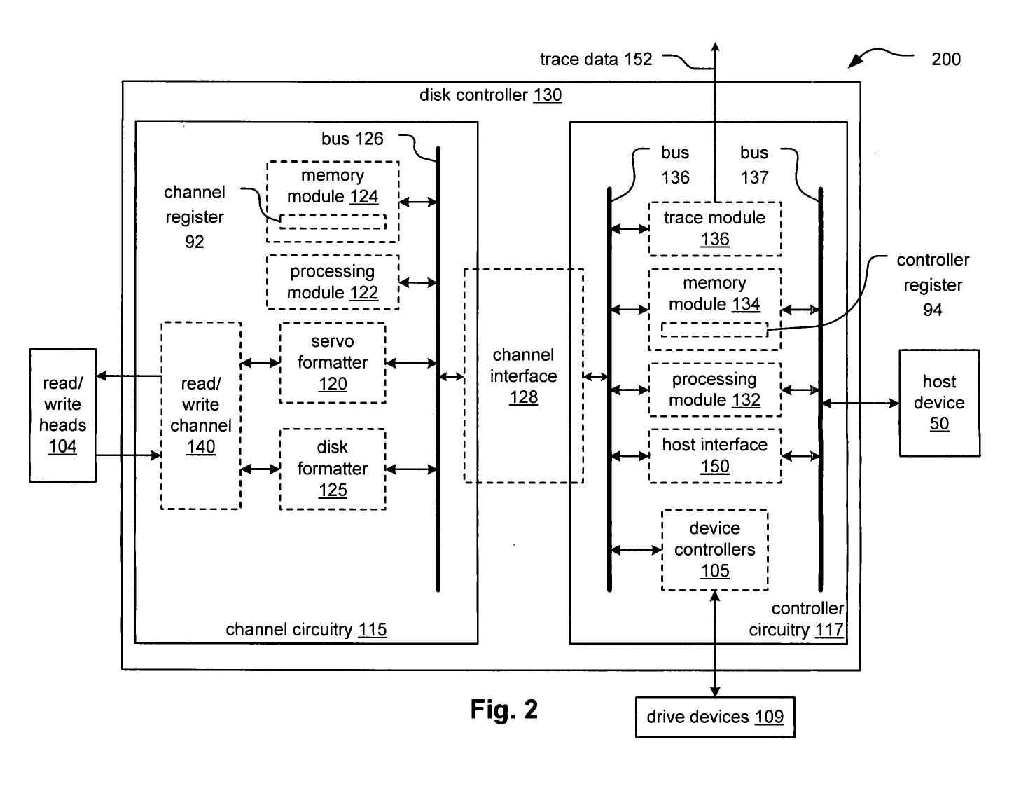

FIG. 2 illustrates an embodiment of an apparatus 200 that includes a disk controller 130 (i.e., a controller employed within a HDD). In particular, the disk controller 130 is implemented with a channel circuitry 115 and a controller circuitry 117 that are coupled together via a channel interface 128 (e.g., a physical layer interface) to perform the functions of the disk controller 130 cooperatively. The channel circuitry 115 includes a read/write channel 140 for reading and writing data to and from the disk 102 through read/write heads 104. A disk formatter 125 is included for controlling the formatting of data and provides clock signals and other timing signals that control the flow of the data written to, and data read from disk 102, and servo formatter 120 provides clock signals and other timing signals based on servo control data read from the disk 102. The controller circuitry 117 includes device controllers 105 that control the operation of drive devices 109 such as the actuator 108 and the servo motor, etc., a trace module 136, for collecting trace data 152, such as stack and register values, processor states and/or other implementation specific data that can be used to observe the internal operations of the disk controller 130, including channel trace data from the channel circuitry 115 and other trace data from other modules of controller circuitry 117. The trace module 136 provides the trace data 152 to an external device (not shown) for diagnostic purposes. If desired, a host device 50 can also be implemented to perform this race functionality which can be employed for various analyses and de-bugging operations.

The controller circuitry 117 further includes a host interface module 150 that receives read and write commands from the host device 50 and transmits data read from the disk 102 along with other control information in accordance with a host interface protocol. In one possible embodiment, the host interface protocol can include any one of the following: Advanced Technology Attachment (ATA)/Integrated Development Environment (IDE), Serial ATA (SATA), Fibre channel ATA (FATA), Small Computer System Interface (SCSI), Enhanced IDE (EIDE), MultiMedia Card (MMC), and Compact Flash (CF) or any number of other host interface protocols, either open or proprietary that can be used for this purpose.

The controller circuitry 117 further includes a processing module 132 and memory module 134. The processing module 132 can be implemented using one or more microprocessors, micro-controllers, digital signal processors, microcomputers, central processing units, field programmable gate arrays, programmable logic devices, state machines, logic circuits, analog circuits, digital circuits, and/or any devices that manipulate signals (analog and/or digital) based on operational instructions that are stored in a memory module 134. When the processing module 132 is implemented with two or more devices, each device can perform the same steps, processes or functions in order to provide fault tolerance or redundancy. Alternatively, the function, steps and processes performed by the processing module 132 can be split between different devices to provide greater computational speed and/or efficiency.

The memory module 134 may be a single memory device or a plurality of memory devices. Such a memory device may be a read-only memory (ROM), random access memory (RAM), volatile memory, non-volatile memory, static random access memory (SRAM), dynamic random access memory (DRAM), flash memory, cache memory, and/or any device that stores digital information. It is noted that when the processing module 132 implements one or more of its functions via a state machine, analog circuitry, digital circuitry, and/or logic circuitry, the memory module 134 storing the corresponding operational instructions may be embedded within, or external to, the circuitry comprising the state machine, analog circuitry, digital circuitry, and/or logic circuitry. It is further noted that, the memory module 134 stores, and the processing module 132 executes, operational instructions to control the operation of drive devices 109, to arbitrate the execution of read and write commands and the flow of data between the host interface module 150 and the channel circuit 115, to gather trace data and to perform other functions of the drive.

Likewise, the channel circuitry 115 further includes a processing module 122 and a memory module 124. The processing module 122 can be implemented using one or more microprocessors, micro-controllers, digital signal processors, microcomputers, central processing units, field programmable gate arrays, programmable logic devices, state machines, logic circuits, analog circuits, digital circuits, and/or any devices that manipulate signals (analog and/or digital) based on operational instructions that are stored in memory module 124. When processing module 122 is implemented with two or more devices, each device can perform the same steps, processes or functions in order to provide fault tolerance or redundancy. Alternatively, the function, steps and processes performed by processing module 122 can be split between different devices to provide greater computational speed and/or efficiency.

The memory module 124 may be a single memory device or a plurality of memory devices. Such a memory device may be a ROM, RAM, volatile memory, non-volatile memory, static random access memory (SRAM), dynamic random access memory (DRAM), flash memory, cache memory, and/or any device that stores digital information. Note that when the processing module 122 implements one or more of its functions via a state machine, analog circuitry, digital circuitry, and/or logic circuitry, the memory module 124 storing the corresponding operational instructions may be embedded within, or external to, the circuitry comprising the state machine, analog circuitry, digital circuitry, and/or logic circuitry. Further note that, the memory module 124 stores, and the processing module 122 executes operational instructions to control the execution of read and write commands and the flow of data between the channel circuitry 115 and controller circuitry 117, to gather trace data from the channel that is provided to trace module 136 and to perform other functions of the drive.

The host interface module 150, as a whole, converts incoming data and commands from the host device 50 in its corresponding host interface protocol, into data and commands in a format used by disk controller 130. Conversely, data from read from disk drive unit 100 is converted by host interface module 150 from the format used by disk drive unit 100 into the particular host interface protocol used by the host device 50. In one embodiment, the format used by the disk controller 130 can be a standard format such as Direct Memory Access (DMA), including the corresponding control capabilities of DMA, that is further implemented to support transfers of read and write data between the channel circuit 115 and the controller circuit 117 via channel interface 128.

In particular, channel circuit 115 includes a channel register 92 and controller circuit 117 includes a controller register 94, that, in conjunction with channel interface 128, are operable to support DMA protocol data transfers and DMA control between the channel circuit 115 and the controller circuit 117. While the channel register 92 is shown as a memory location of the memory module 124, the channel register 92 can be implemented as a register or memory that is either stand-alone, or implemented as part of another device, such as a processing module 122. Similarly, while the controller register 94 is shown as a memory location of memory module 134, the controller register 94 can be implemented as a register or memory that is either stand-alone, or implemented as part of another device, such as a processing module 132.

The disk controller 130 includes a plurality of modules, in particular, device controllers 105, the trace module 136, the processing module 122, the processing module 132, memory modules 124 and 134, the read/write channel 140, the disk formatter 125, the servo formatter 120, and the host interface module 150 that are interconnected via channel interface 128 and buses 126, 136 and 137. Each of these modules can be implemented in hardware, firmware, software or a combination thereof. While a particular bus architecture is shown in FIG. 2 with buses 126, 136 and 137, alternative bus architectures that include fewer or additional data buses, and/or alternative connectivity, such as direct connectivity between the various modules, are likewise possible to implement the features and functions included in the various embodiments of the present invention.

In one possible embodiment, channel circuitry 115 and controller circuitry 117 are each implemented with an integrated circuit (IC) such as a system on a chip integrated circuit (SoC IC). If desired, such a SoC IC includes a digital portion that can include additional modules such as protocol converters, linear block code encoding and decoding modules, etc., and an analog portion that includes additional modules, such as a power supply, disk drive motor amplifier, disk speed monitor, read amplifiers, etc. In a further embodiment, the various functions and features of channel circuitry 115 and/or controller circuitry 117 are implemented using two or more IC devices that communicate and combine to perform the functionality of channel circuitry 115 and/or controller circuitry 117 in conjunction with channel interface 128. Further details regarding various embodiment of a channel interface (sometimes referred to a physical layer interface) including additional novel features and functions are described in conjunction with the figures that follow.

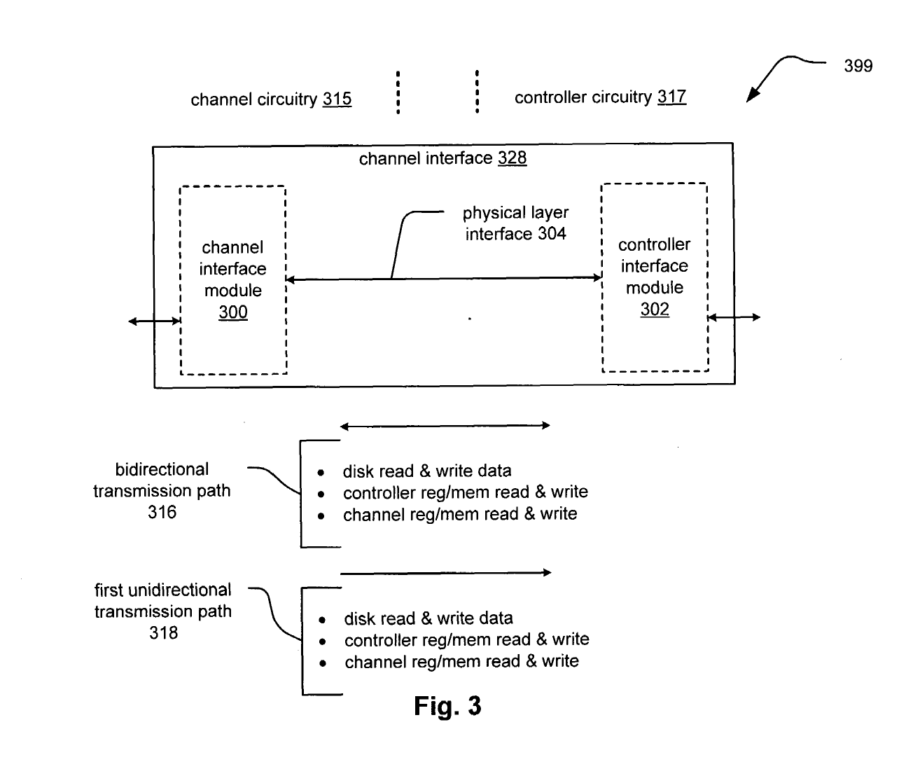

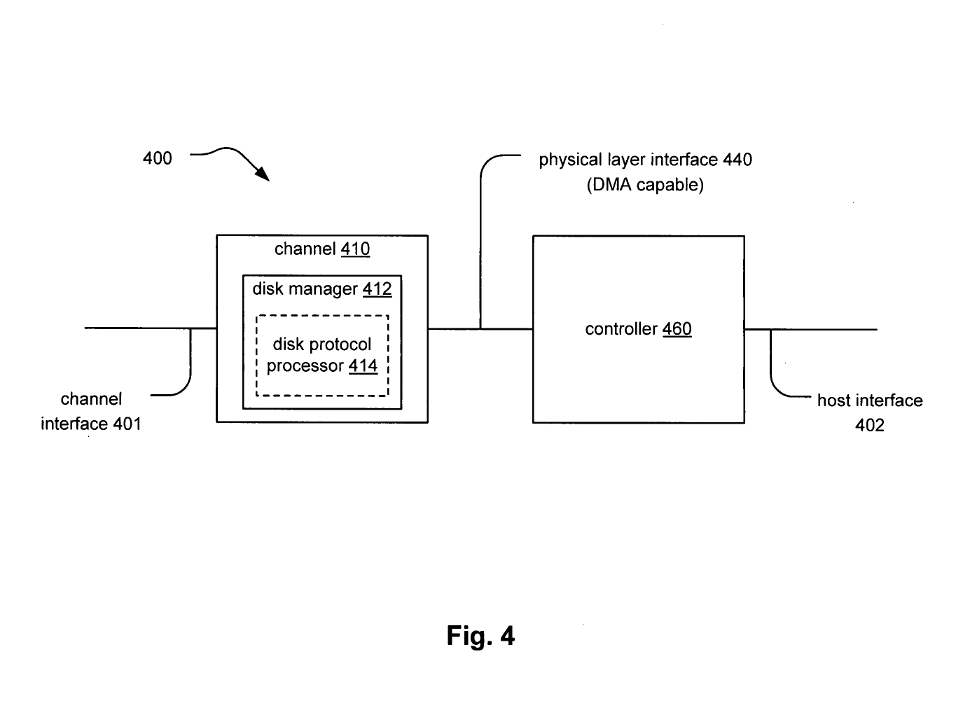

FIG. 3, FIG. 4, FIG. 5, FIG. 6A, FIG. 6B, FIG. 7A, FIG. 7B, and FIG. 8 illustrate various embodiments of an apparatus that includes a channel interface.

Referring to the apparatus 399 of the FIG. 3, this diagram includes a channel interface 328. In particular, the channel interface 328 is presented that includes a channel interface module 300 of a channel circuitry 315 that is coupled to a controller circuitry 317 via a physical layer interface 304 and a controller interface module 302. In an embodiment where the channel circuitry 315 and the controller circuitry 317 are implemented using separate ICs, the physical later interface 304 includes one or more wires or cables that provide a signaling path between a plurality of pins of the channel circuitry 315 and a plurality of pins of the channel circuitry 317. As used herein, the terms “pins” shall refer generically to any structure for coupling signals from a circuit for connection to an external device. As such, the term pins shall include pads, bonding wires, and other electrical, electromagnetic and/or optical connections that can be implemented to effectuate such an electrical signal connection.

The channel interface 328 includes a bidirectional transmission path 316 between the controller circuitry 117 and the channel circuitry 115 that is operable to transfer disk read data and disk write data, to provide the controller circuit access to read from, and write to, a channel register (e.g., such as the channel register 92 of FIG. 2), and to provide the channel circuit access to read from, and write to, the controller register (e.g., such as the controller register 94 of FIG. 2).

However, other data transfers, for interface management or for other control and signaling purposes are likewise possible with the broader scope of the present invention. Providing the channel circuitry 315 access to read from, and write to, the controller register, and providing the controller circuit access to read from, and write to, the channel register, allows the channel interface 328 to support certain data transfers, such as DMA transfers of blocks of data corresponding to, for instance, one or more sectors of data, or fractions thereof, from the drive. In operation, these data transfers are formatted with a command code, such as: a code for a channel register write, channel register read, controller register write, or controller register read, etc; command specific data, such as the register address, write data, data size, etc; and other control information, headers footers, error detection and/or correction codes, etc. In an embodiment of the present invention, the bidirectional transmission path 316 includes separate forward and reverse transmission paths that allow bidirectional transactions that optionally include requests for transfer, transfers and/or acknowledgement or transfers, to be split between the forward and reverse paths based on the direction of command and data flow.

In addition, the channel interface 328 includes a unidirectional transmission path 318 that is operable to transfer data from the channel circuitry 315 to the controller circuitry 317 such as servo data, interrupt requests for a processing module (e.g. such as the processing module 132 of the FIG. 2), and channel trace data for a trace module (e.g., such as the trace module 136 of the FIG. 2). In an embodiment, the unidirectional transmission path 318 is implemented separately from the bidirectional transmission path to provide a dedicated pathway for real-time transfers of servo data and interrupts, whose timing is potentially important to the operation of the controller circuitry 317.

Referring to the apparatus 400 of the FIG. 4, from a relatively high level, this diagram shows how the partitioning of a 2 circuitry implementation can place the interface in a different location that is employed within the prior art. In this embodiment, a channel circuitry 410, that includes a disk manager module 412, and a controller circuitry 460 are coupled via a physical layer interface 440. The physical layer interface 440 is operable to support direct memory access (DMA) protocol data transfers and corresponding DMA control between the controller circuitry 460 and the channel circuitry 410. If desired, the disk manager module 412 can be implemented to include an embedded disk protocol processor 414 that is operable to govern an access protocol employed during read and write access to the disk within the HDD.

The channel circuitry 410 is operable to perform a first plurality of operations that includes operations corresponding to read and write access to a disk within the HDD via a channel interface 401, and the controller circuitry 460 is operable to perform a second plurality of operations that includes operations corresponding to host interfacing via a host interface 402.

As opposed to many prior art approaches that seek to use a 2 circuitry implementation of a channel circuitry and a controller circuitry, by implementing the disk management capability on the channel circuitry, as described with reference to the FIG. 4, allows for a much more flexible interface between the controller circuitry 460 and the channel circuitry 410. For example, by moving the physical layer interface 440 here, this allows for a great deal of flexibility in the type of interface employed as well as the types of protocols that can be employed. As one example, the very adaptable and flexible protocol of DMA can be employed when the physical layer interface 440 is implemented here because the rigidity and complexity required within prior art approaches is obviated. The type of interface can be any of a broad ranges of interface types (e.g., parallel connectivity, serializer/de-serializer (SERDES) interfacing, etc.). In addition, this flexibility in implementation allows designers to implement this interface with fewer pin and parallel wire count than prior art schemes.

For example, many prior art approaches sought to employ the disk management operations on a controller circuitry, and when a 2 circuitry approach was desired, then the physical interface employed therein had to accommodate all of the disk related access commands and functions across the interface. Much of problem associated with this prior art approach was simply due to legacy architectures and earlier designs to which later designs needed to comply. The novel and improved approach of making the physical layer interface 440 between the controller circuitry 460 and the channel circuitry 410 such that the disk manager module 412 now resides on the channel circuitry 410 provides for numerous benefits when compared to the prior art approaches. Generally speaking, in a 2 circuitry implementation, the physical layer interface 440 can be viewed as being on a different side of the physical layer interface 440 than is existent within prior art approaches.

Referring to the apparatus 500 of the FIG. 5, the apparatus 500 includes a controller circuitry 560 and a channel circuitry 510 that are coupled via a physical layer interface 540. The physical layer interface 540 is operable to support DMA protocol data transfers and corresponding DMA control between the controller circuitry 560 and the channel circuitry 510. Within each of the controller circuitry 560 and the channel circuitry 510 is implemented a channel interface module (i.e., the channel interface module 521 within the channel circuitry 510 and the channel interface module 571 within the controller circuitry 560). A physical layer component 522 and a physical layer component 572 allow the interfacing of the channel interface modules 521 and 571, respectively, to the physical layer interface 540.

The controller circuitry 560 includes a host manager module 570, and the channel circuitry 510 includes a disk manager module 512. Each of the host manager module 570 and the disk manager module 512 has an embedded protocol processor. Specifically, a disk protocol processor 514 is implemented within the disk manager module 512 and a host protocol processor 572 is implemented within the host manager module 570. To facilitate inter-processor communication, a shared data cache 564 is included in the apparatus 500. The shared data cache 564 is shown as being implemented within the controller circuitry 560, and it is operable to communicate with the disk protocol processor 514 implemented within the channel circuitry 510 via the physical later interface 540.

Each of the 3 processors (a centralized, general purpose processor 562, the disk protocol processor 514, and the host protocol processor 572) can read and write shared data structures (stored in the buffer) to help manage the real-time functions performed by the two protocol processors (disk protocol processor 514 and the host protocol processor 572). The shared data cache 564 provides for hardware-enforced coherency of these shared accesses.

The host interface 502 is controlled with the host manager module 570 that is operable to move data between the host interface 502 and a buffer 590 through a buffer manager module 567. The disk manager module 512 controls many of the various components that eventually couple to a channel interface 501 and moves data between the channel and the buffer 590 through the buffer manager module 567 (after appropriately negotiating the physical layer interface 540). The buffer manager module 567 arbitrates access to the shared buffer 590, which can be implemented in the DRAM.

The host manager module 570 also includes a host personality module 576 that is operable to perform and enable host interfacing with various types of hosts via the host interface 502. The host protocol processor 572, implemented within the host manager module 570, is operable to support soft key mapping which allows the host personality module 576 to emulate more than one type of host compatible interface. For example, the soft key mapping employed therein allows the host personality module 576 to interface properly with a first type of host device and to interface properly with a second type of host device, depending on which soft key is employed. This way, a singular piece of hardware can be employed across a wide range of platforms.

A host first-in/first-out (FIFO) buffer 574 is implemented within the host manager module 570 as well, and it interacts with the host personality module 576. The host FIFO 574 interfaces with the buffer manager module 567 in the manner as described above, in that, the host manager module 570 is operable to move data between the host interface 502 and the buffer 590 through the buffer manager module 567 via the host personality module 576 and the host FIFO 574.

The disk manager module 512 can also be implemented to include a servo formatter module 531 that is operable to format commands and functions into the appropriate format for execution within a servo control loop. The disk manager module 512 also includes a disk datapath module 536 that is operable to interface with the buffer manager module 567. The disk datapath module 536 employs a first error correction code (ECC) 535, shown as being implemented within ended module 537, when encoding or decoding information provided to and received from the buffer manager module 567.

It is noted that the type of channel that couples to the disk of the HDD is sometimes referred to as an iterative channel when an iterative ECC is employed to encode/decode the information written to and read from the disk. In some embodiments, the type of interface employed for the channel (i.e., a disk interface) is a first interface type, and the type of interface employed for the physical layer interface 540 that couples the controller circuitry 560 and the channel circuitry 510 is a second interface type. In other words, these interface types need not be the same. It is sometimes desirable to select the particular code employed for the ECC based on the interface type and/or channel type of the disk interface employed for the channel. An appropriately selected ECC, based on the characteristics of the channel and/or the disk interface, may provide for better error correcting capability.

The disk manager module 512 also includes a disk formatter module 534 that is operable to perform the appropriate formatting for information to be written to the disk via a write path and de-formatting of information that is read from the disk via a read path.

The path for writing into to the disk from the disk formatter module 535 is shown as first passing through an encoder 516 that employs a second ECC, shown as endec2. In some instances, this second ECC can be implemented using an LDPC (Low Density Parity Check) code. The encoded information is then provided to a parity encoder 517, whose output couples to a write precompensation module 518 that eventually couples to an analog front end (AFE) 531, that is operable to perform any of a variety of analog processing functions including digital to analog conversion, scaling (e.g., gain or attenuation), digital filtering (before converting to continuous time domain), continuous time filtering (after converting to continuous time domain), or other signal processing functions required to comport the signal into a format compatible with the channel interface 501. The AFE 531 also includes a preamp 532 that is often implemented as part of the read head assembly.

The path for reading from the disk is the converse of the write path to the disk. For example, when coming from the channel interface 501, the signal is provided initially to the AFE 531, in which the converse of many of the signal processing operations within the write process is performed. For example, an analog to digital conversion is performed, scaling, and/or filtering, among other signal processing operations.

After passing from the AFE 531 during a read process, the signal passes through a finite impulse response filter (FIR) 528, a Viterbi decoder 527 that is operable to employ the soft output Viterbi algorithm (SOVA) to determine a soft output that is indicative of the reliability of the information within the digital signal. For example, the Viterbi decoder 527 is operable to determine whether the digital signal provided to it is reliable or not. In addition, the Viterbi decoder 527 can be viewed as performing the parity decoding processing in the read path in response to the parity encoding processing (that is performed by the parity encoder 517) in the write path. The output from this Viterbi decoder 527 as provided to a decoder 526 that employs the same code as the encoder 516, namely, the second ECC, shown as endec2. The output from this decoder 526 is provided to the disk formatter module 534.

Referring to the apparatus 601 of the FIG. 6A, this diagram shows how a channel circuitry 610 and a controller circuitry 660, such as would be implemented within a HDD, are implemented using two separate circuitries that are coupled via a 2 wire serializer/de-serializer (SERDES) physical layer interface 640. The channel circuitry 610 includes a serializer 612 and a de-serializer 614, and the controller circuitry 660 also includes a corresponding serializer 662 and a corresponding de-serializer 664.

The serializer 612 of the channel circuitry 610 is operable to convert parallel type data into a serial format for transmission across one of the wires of the 2 wire SERDES physical layer interface 640 to the de-serializer 664 of the controller circuitry 660, where the data can then be re-converted back to parallel type formatted data.

Analogously, the serializer 662 of the controller circuitry 660 is operable to convert parallel type data into a serial format for transmission across one of the wires of the 2 wire SERDES interface 640 to the de-serializer 614 of the channel circuitry 610, where the data can then be re-converted back to parallel type formatted data.

Referring to the apparatus 602 of the FIG. 6B, this diagram is similar to FIG. 6A, with a different being that a 1 wire SERDES physical layer interface 650 is employed to couple a channel circuitry 620 and a controller circuitry 670. Similar to the previous embodiment, the channel circuitry 620 includes a serializer 622 and a de-serializer 624, and the controller circuitry 670 also includes a corresponding serializer 672 and a corresponding de-serializer 674.

However, because of the implementation of the 1 wire SERDES physical layer interface 650 over which data is transmitted in both directions, each of the channel circuitry 620 and the controller circuitry 670 includes a corresponding arbitrator, namely 626 and 676, respectively. Each of the arbitrators 626 and 676 is operable to arbitrate the transmission and receipt functionality of the channel circuitry 620 and the controller circuitry 670, respectively, when using the 1 wire SERDES physical layer interface 650. For example, when the serializer 622 of the channel circuitry 620 desires to transmit serial formatted information across the 1 wire SERDES physical layer interface 650 to the de-serializer 674 of the controller circuitry 670, then the arbitrators 626 and 676 need to ensure that such a transmission is timely and can be performed without losing any other data or information.

Analogously, when the serializer 672 of the controller circuitry 670 desires to transmit serial formatted information across the 1 wire SERDES physical layer interface 650 to the de-serializer 624 of the channel circuitry 620, then the arbitrators also 626 and 676 need to ensure that such a transmission is timely and can be performed without losing any other data or information.

Referring to the apparatus 701 of the FIG. 7A, this diagram shows how a channel circuitry 710 and a controller circuitry 760, such as would be implemented within a HDD, are implemented using two separate circuitries that are coupled via a parallel physical layer interface 740. The channel circuitry 710 includes a plurality of pins 711, and the controller circuitry 760 also includes a plurality of pins 761 such that the number of paths within the parallel physical layer interface 740 corresponds to the number of pins 711 and the number of pins 761. Certain of the paths within the parallel physical layer interface. 740 support uni-directional communication of information from the channel circuitry 710 to the controller circuitry 760, and other of the paths within the parallel physical layer interface 740 support uni-directional communication of information from the controller circuitry 760 to the channel circuitry 710. In some embodiments, half of paths are dedicated for transmission in each of the directions, but more paths can be dedicated to support one direction if desired in some embodiments.

Referring to the apparatus 702 of the FIG. 7B, this embodiment is somewhat analogous to the embodiment of FIG. 7A, but a parallel physical layer interface 750 that couples a channel circuitry 720 and a controller circuitry 770 is operable to support bi-directional communication across each of the paths therein. If desired, each of the channel circuitry 720 and the controller circuitry 770 can also be implemented to include an arbitrator (as described within other embodiments herein) to ensure appropriate communications via the parallel physical layer interface 750 such that no data and/or information is lost in the process.

The channel circuitry 720 includes a plurality of pins 721, and the controller circuitry 770 also includes a plurality of pins 771 such that the number of paths within the parallel physical layer interface 750 corresponds to the number of pins 721 and the number of pins 771.

Clearly, the number of pins within any of the previous embodiments can be selected as desired for use is any of a variety of various applications. It is also noted that some combination of parallel/serial type physical layer interface may be implemented between a channel circuitry and a controller circuitry, such as would be implemented within a HDD. For example, a 16 bit wide signal could be converted down to 4 separate serialized signals containing the information of 4 of the bits of the 16 bit wide signal, and the 4 separate serialized signals could be transmitted across the physical layer interface as well.

Referring to the apparatus 899 of the FIG. 8, this diagram includes a channel interface module 800, controller interface module 802 and a physical layer interface 804. In particular, a bidirectional transmission path 814 is implemented with differential line drivers 836 and 823, differential line amplifiers 826 and 833, and transmitter/receiver pairs 834/824 and 822/832. A unidirectional transmission path 818 is implemented with differential line driver 821, differential line amplifier 831, and transmitter/receiver pair 820/830.

In one possible embodiment, the bidirectional transmission path 816, and unidirectional transmission path 818 form a plurality of parallel arranged paths that are part of a serializer/de-serializer (SERDES) interface. In particular, bidirectional transmission path 816 contains two differential line pairs and the unidirectional transmission path 818 includes one differential line pair. Parallel data is serialized for high-speed transfer over a physical layer interface 804. The transmitter 834, primary transmitter 822, and secondary transmitter 820 encode the incoming data using signaling such as low voltage differential signaling (LVDS) that is transferred across the parallel paths by differential line drivers 836, 823 and 821 operating in conjunction with differential line amplifiers 826, 833, and 831. The receiver 824, primary receiver 832 and secondary receiver 830 operate to convert the LVDS back into its corresponding data.

In addition to the bidirectional transmission path 816 and unidirectional transmission path 818, the physical layer interface 804 includes unidirectional transmission path 814 that couples a clock signal 838 from a controller circuitry and a channel circuitry (e.g., such as the controller circuitry 117 and the channel circuitry 115 of the FIG. 2). In this configuration, differential line driver 837 transfers clock signal 838 over the physical interface for recovery by line amplifier 827 to form clock signal 838′.

In this configuration, the physical layer interface 804 includes eight signal lines that make up four parallel signal paths. In this fashion, the physical interface can include eight circuit board traces, wires or other connections that couple eight pins of a channel circuit to eight pins of a controller circuitry. However, other configurations are likewise possible. For instance, fewer than eight signal lines can be used to implement the physical layer interface 804 by employing one or more common ground connections. In other alternatives, the physical interface may omit the transfer of clock signal 838 and the unidirectional transmission path 814, or provide a clock signal in the opposite direction, from a channel circuitry to a controller circuitry.

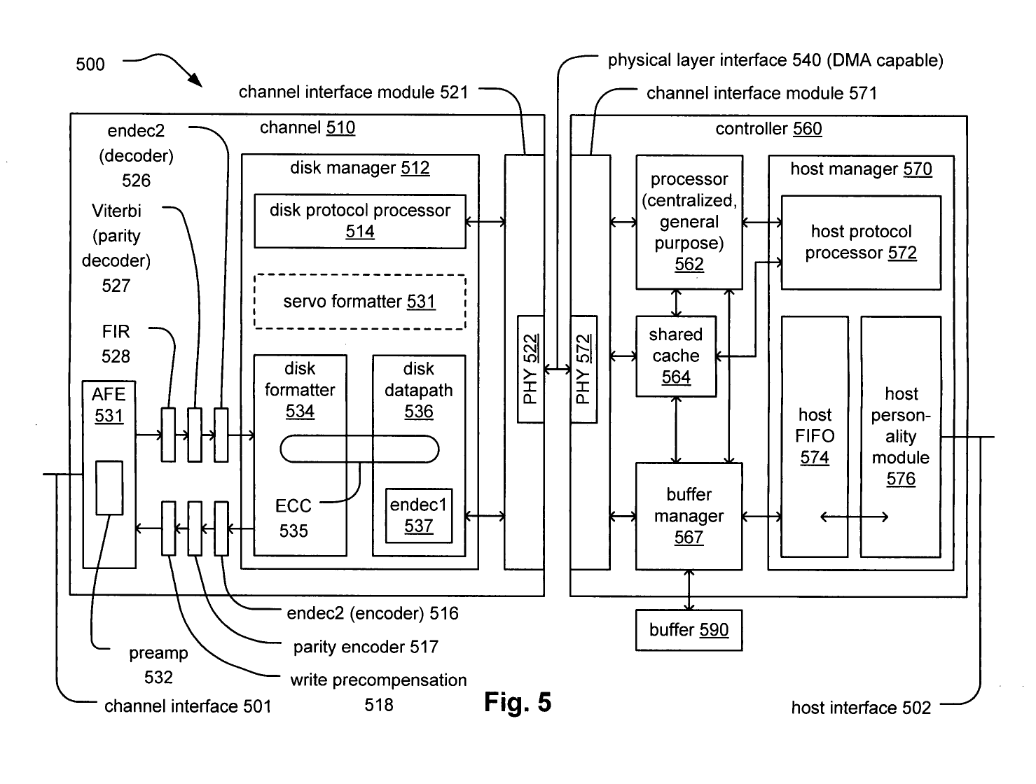

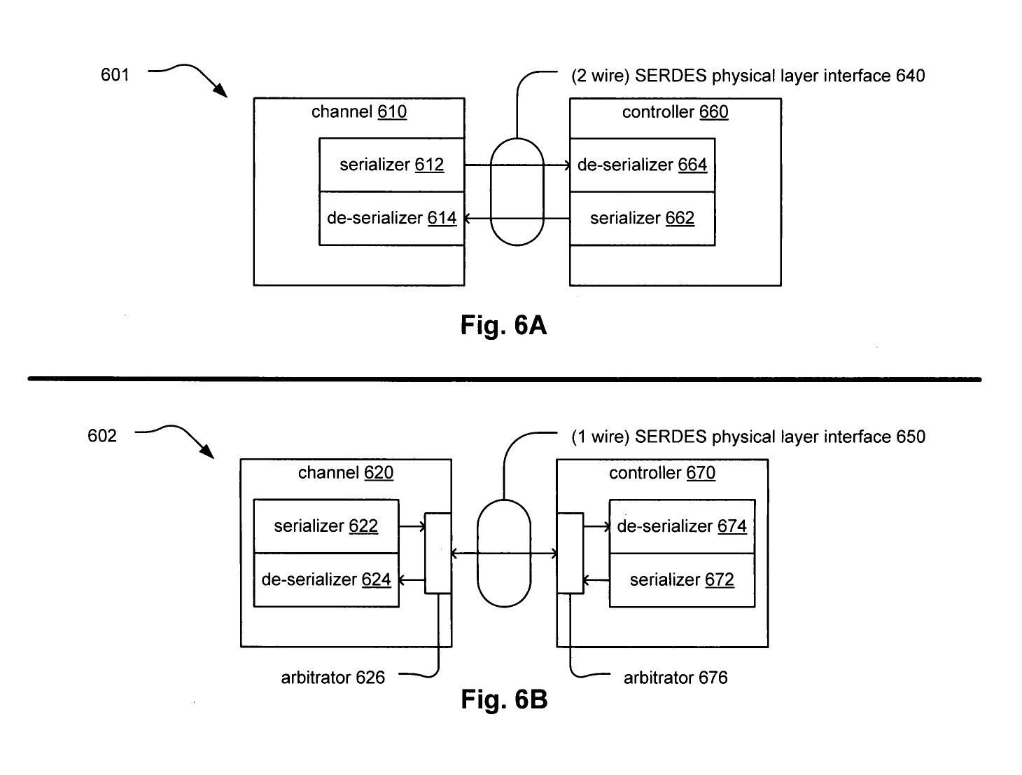

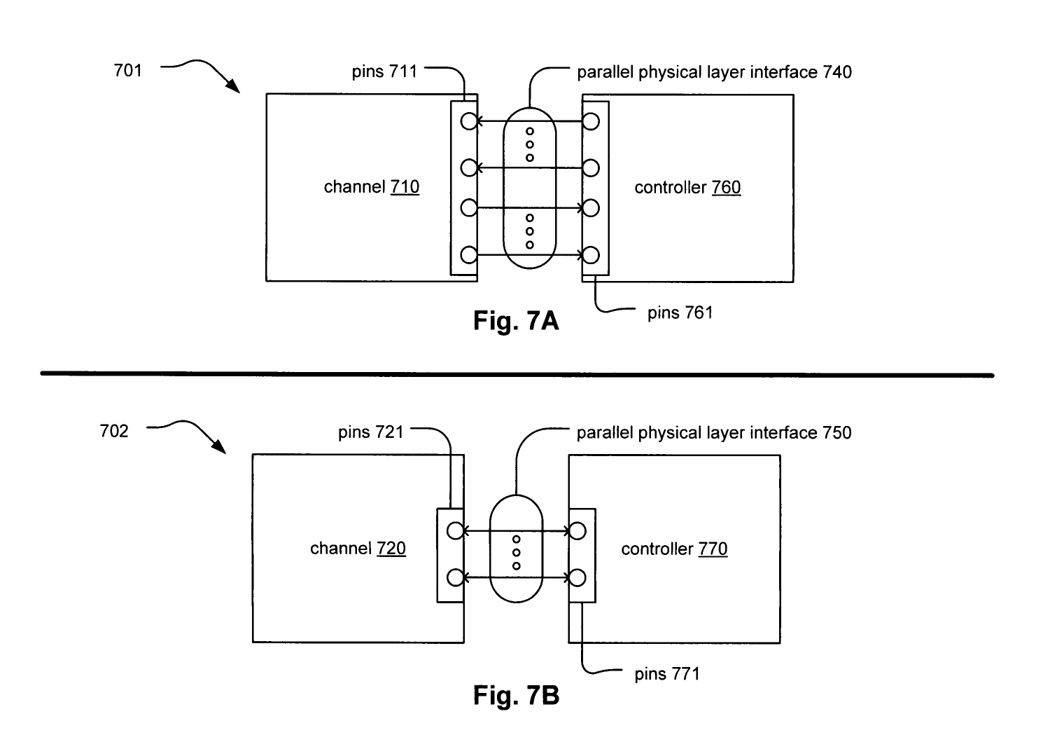

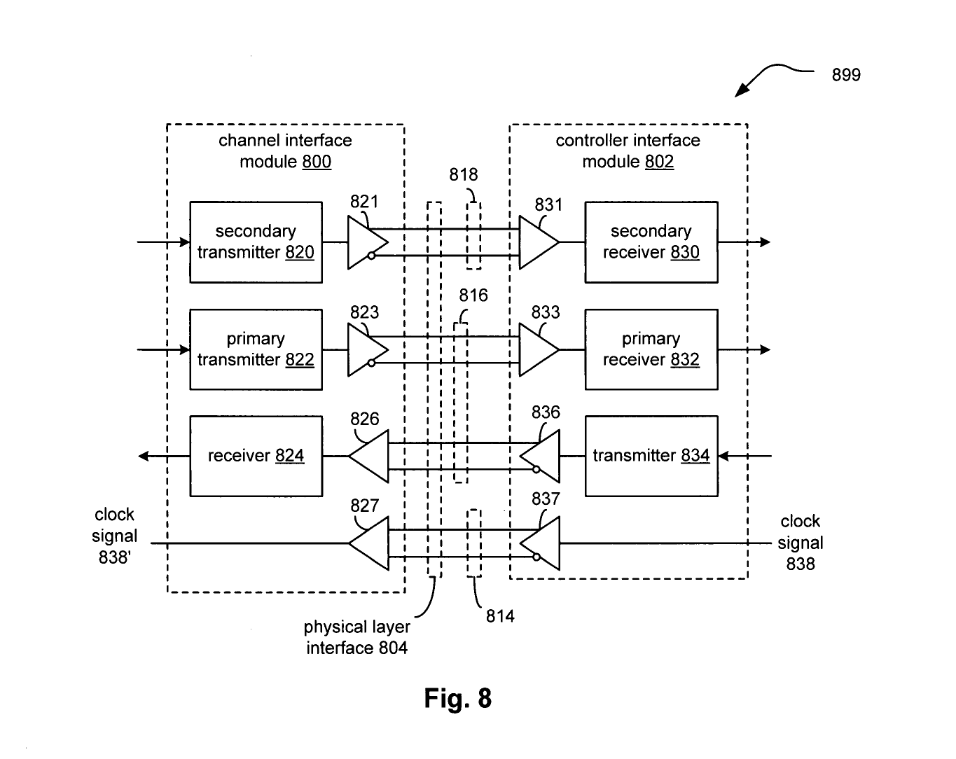

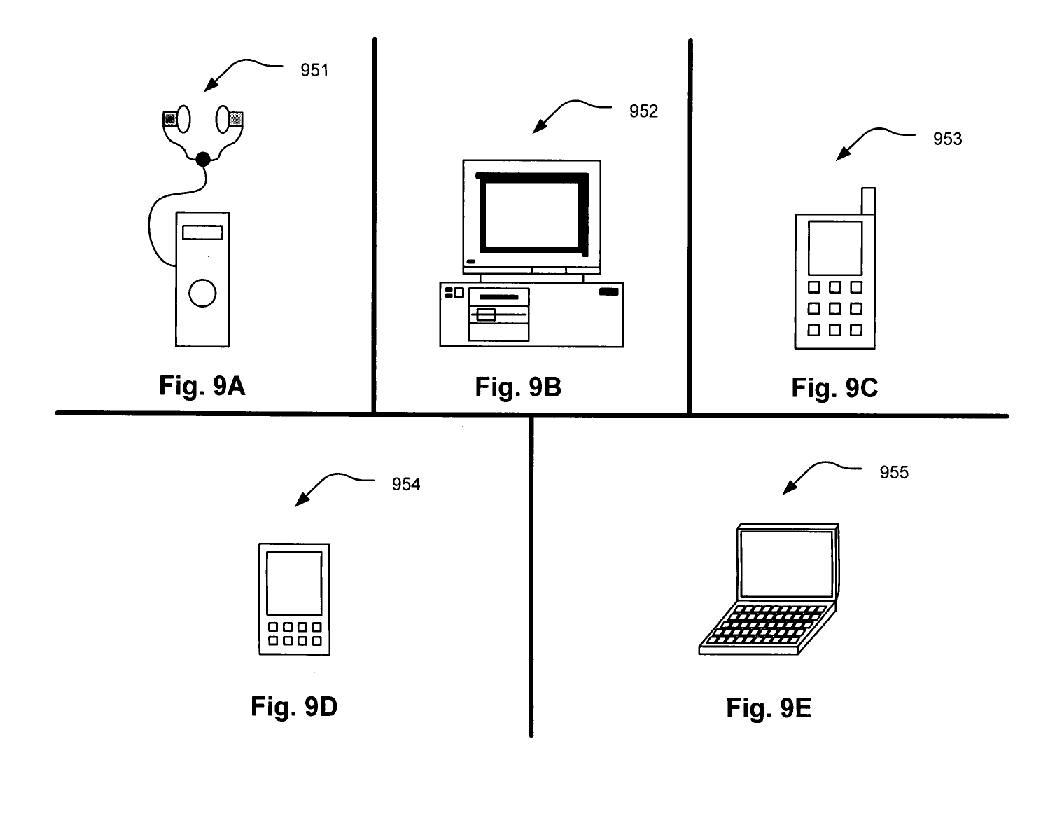

FIG. 9A illustrates an embodiment of a handheld audio unit 951. In particular, a HDD unit (such as the disk drive unit 100 of the FIG. 1) can be implemented in the handheld audio unit 951. In one possible embodiment, the HDD unit can include a small form factor magnetic hard disk whose disk has a diameter 1.8″ or smaller that is incorporated into or otherwise used by handheld audio unit 951 to provide general storage or storage of audio content such as motion picture expert group (MPEG) audio layer 3 (MP3) files or Windows Media Architecture (WMA) files, video content such as MPEG4 files for playback to a user, and/or any other type of information that may be stored in a digital format.

FIG. 9B illustrates an embodiment of a computer 952. In particular, a HDD HDD unit (such as the disk drive unit 100 of the FIG. 1) can be implemented in the computer 952. In one possible embodiment, the HDD unit can include a small form factor magnetic hard disk whose disk has a diameter 1.8″ or smaller, a 2.5″ or 3.5″ drive or larger drive for applications such as enterprise storage applications. The HDD unit is incorporated into or otherwise used by computer 952 to provide general purpose storage for any type of information in digital format. The computer 952 can be a desktop computer, or an enterprise storage devices such a server, of a host computer that is attached to a storage array such as a redundant array of independent disks (RAID) array, storage router, edge router, storage switch and/or storage director.

FIG. 9C illustrates an embodiment of a wireless communication device 953. In particular, an HDD unit (such as the disk drive unit 100 of the FIG. 1) can be implemented in the wireless communication device 953. In one possible embodiment, the HDD unit can include a small form factor magnetic hard disk whose disk has a diameter 1.8″ or smaller that is incorporated into or otherwise used by wireless communication device 953 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats that may be captured by an integrated camera or downloaded to the wireless communication device 953, emails, webpage information and other information downloaded from the Internet, address book information, and/or any other type of information that may be stored in a digital format.

In a possible embodiment, wireless communication device 953 is capable of communicating via a wireless telephone network such as a cellular, personal communications service (PCS), general packet radio service (GPRS), global system for mobile communications (GSM), and integrated digital enhanced network (iDEN) or other wireless communications network capable of sending and receiving telephone calls. Further, wireless communication device 953 is capable of communicating via the Internet to access email, download content, access websites, and provide steaming audio and/or video programming. In this fashion, wireless communication device 953 can place and receive telephone calls, text messages such as emails, short message service (SMS) messages, pages and other data messages that can include attachments such as documents, audio files, video files, images and other graphics.

FIG. 9D illustrates an embodiment of a personal digital assistant (PDA) 954. In particular, a HDD unit (such as the disk drive unit 100 of the FIG. 1) can be implemented in the personal digital assistant (PDA) 54. In one possible embodiment, disk drive unit 100 can include a small form factor magnetic hard disk whose disk 102 has a diameter 1.8″ or smaller that is incorporated into or otherwise used by personal digital assistant 54 to provide general storage or storage of audio content such as motion picture expert group (MPEG) audio layer 3 (MP3) files or Windows Media Architecture (WMA) files, video content such as MPEG4 files, JPEG joint photographic expert group) files, bitmap files and files stored in other graphics formats, emails, webpage information and other information downloaded from the Internet, address book information, and/or any other type of information that may be stored in a digital format.

FIG. 9E illustrates an embodiment of a laptop computer 955. In particular, a HDD unit (such as the disk drive unit 100 of the FIG. 1) can be implemented in the laptop computer 955. In one possible embodiment, the HDD unit can include a small form factor magnetic hard disk whose disk has a diameter 1.8″ or smaller, or a 2.5″ drive. The HDD unit is incorporated into or otherwise used by laptop computer 952 to provide general purpose storage for any type of information in digital format.

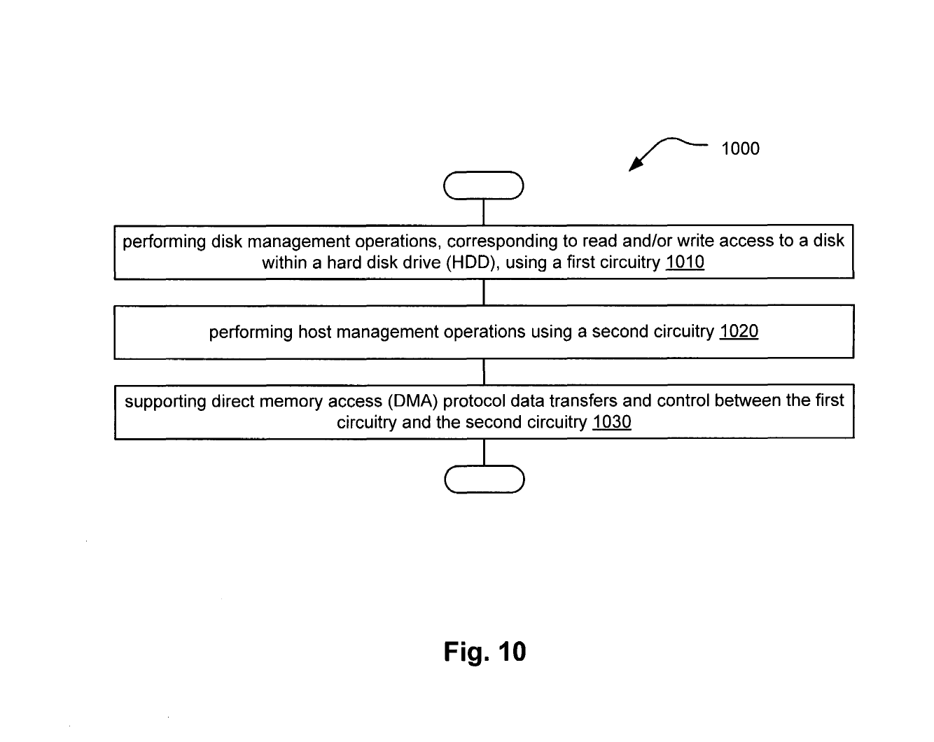

FIG. 10 illustrates an embodiment of a method for supporting an interface between multiple integrated circuits (ICs). The method 1000 begins by performing disk management operations, corresponding to read and/or write access to a disk within a hard disk drive (HDD), using a first circuitry, as shown in a block 1010. This step can be performed using a channel circuitry in some embodiments, or within such a disk manager module within a channel circuitry. The method 1000 then continues by performing host management operations using a second circuitry, as shown in a block 1020. This step can be performed using a controller circuitry in some embodiments, or within such a host manager module within a controller circuitry.

Then, because of the location in which the disk management operations are supported and performed within the first circuitry, the method 1000 is operable to perform supporting direct memory access (DMA) protocol data transfers and control between the first circuitry and the second circuitry, as shown in a block 1030. Because the disk management operations are supported within the first circuitry, as opposed to the second circuitry, then the disk management operations need not necessarily comply with an interface between the first circuitry and the second circuitry. This allows for better control of the disk management operations as well as a much broader range and type of interface that can be employed for the interface between the first circuitry and the second circuitry.

It is also noted that the methods described within the preceding figures may also be performed within any appropriate system and/or apparatus designs without departing from the scope and spirit of the invention.

In view of the above detailed description of the invention and associated drawings, other modifications and variations will now become apparent. It should also be apparent that such other modifications and variations may be effected without departing from the spirit and scope of the invention.

What is claimed is:

1. An apparatus, comprising:
a channel circuitry, that includes a disk manager module, that is operable to perform a first plurality of operations that includes operations corresponding to read and write access to a disk within a hard disk drive;
a controller circuitry that is operable to perform a second plurality of operations that includes operations corresponding to host interfacing; and
a physical layer interface that couples the channel circuitry and the controller circuitry and that is operable to support direct memory access (DMA) protocol data transfers and DMA control between the channel circuitry and the controller circuitry.

2. The apparatus of claim 1, wherein:
one operation of the first plurality of operations is:
error correction encoding of first information that is written to the disk; or
error correction decoding of second information that is read from the disk.

3. The apparatus of claim 1, wherein:
the disk manager module includes a disk protocol processor that is operable to govern an access protocol employed during read and write access to the disk within the hard disk drive.

4. The apparatus of claim 1, wherein:
the physical layer interface includes a plurality of parallel arranged paths.

5. The apparatus of claim 1, wherein:
the physical layer interface is a serializer/de-serializer (SERDES) interface.

6. The apparatus of claim 1, wherein:
the channel circuitry employs an error correction coding to encode first information to be written to the disk during write access and to decode second information to be read from the disk during read access; and
the error correction coding is selected based on a disk interface through which the channel circuitry communicates to the disk for read and write access.

7. The apparatus of claim 1, wherein:
the physical layer interface that couples the channel circuitry and the controller circuitry is a first interface type; and
a disk interface through which the channel circuitry communicates to the disk for read and write access is a second interface type.

8. The apparatus of claim 1, wherein:
the physical layer interface includes a plurality of parallel arranged paths;
the channel circuitry is a first integrated circuit that includes a first plurality of pins such that each pin thereof corresponds to one path of the plurality of parallel arranged paths; and
the controller circuitry is a second integrated circuit that includes a second plurality of pins such that each pin thereof corresponds to one path of the plurality of parallel arranged paths.

9. The apparatus of claim 8, wherein:
the first plurality of pins and the second plurality of pins each include 8 or fewer pins.

10. The apparatus of claim 1, wherein:
the controller circuitry includes a trace module that is operable to trace all connectivity within the channel circuitry via the physical layer interface.

11. The apparatus of claim 1, further comprising a host device that is operable to:
communicate with the controller circuitry via at least one additional physical layer interface that couples the host device and the controller circuitry;
trace all connectivity within the controller circuitry via the at least one additional physical layer interface; and
trace all connectivity within the channel circuitry via the physical layer interface that couples the channel circuitry and the controller circuitry.

12. An apparatus, comprising:
a channel circuitry, that includes a disk manager module, that is operable to perform a first plurality of operations that includes:
error correction encoding of first information that is written to a disk within a hard disk drive; and
error correction decoding of second information that is read from the disk within the hard drive;
a controller circuitry, coupled to the channel circuitry, that is operable to perform a second plurality of operations; and wherein:
the channel circuitry is operable to support direct memory access (DMA) protocol data transfers to and from the controller circuitry; and
the controller circuitry is operable to support DMA protocol data transfers to and from the channel circuitry.

13. The apparatus of claim 12, wherein:
one operation of the first plurality of operations is:
error correction encoding of first information that is written to the disk; or
error correction decoding of second information that is read from the disk.

14. The apparatus of claim 12, wherein:
the disk manager module includes a disk protocol processor that is operable to govern an access protocol employed during read and write access to the disk within the hard disk drive.

15. The apparatus of claim 12, wherein:
the DMA protocol data transfers between the channel circuitry and the controller circuitry are performed across a physical layer interface that couples the channel circuitry and the controller circuitry; and wherein:
the physical layer interface includes a plurality of parallel arranged paths.

16. The apparatus of claim 12, wherein:
the DMA protocol data transfers between the channel circuitry and the controller circuitry are performed across a physical layer interface that couples the channel circuitry and the controller circuitry; and wherein:
the physical layer interface is a serializer/de-serializer (SERDES) interface.

17. The apparatus of claim 12, wherein:
the DMA protocol data transfers between the channel circuitry and the controller circuitry are performed across a physical layer interface that couples the channel circuitry and the controller circuitry;
the physical layer interface that couples the channel circuitry and the controller circuitry is a first interface type; and
a disk interface through which the channel circuitry communicates to the disk for read and write access is a second interface type.

18. The apparatus of claim 12, wherein:
the DMA protocol data transfers between the channel circuitry and the controller circuitry are performed across a physical layer interface that couples the channel circuitry and the controller circuitry; and wherein:
the physical layer interface includes 8 or fewer parallel arranged paths;
the channel circuitry is a first integrated circuit that includes 8 or fewer pins that couple to the physical layer interface such that each pin thereof corresponds to one path of the 8 or fewer parallel arranged paths; and
the controller circuitry is a second integrated circuit that includes 8 or fewer pins that couple to the physical layer interface such that each pin thereof corresponds to one path of the 8 or fewer parallel arranged paths.

19. The apparatus of claim 1, wherein:
the DMA protocol data transfers between the channel circuitry and the controller circuitry are performed across a physical layer interface that couples the channel circuitry and the controller circuitry; and
the controller circuitry includes a trace module that is operable to trace all connectivity within the channel circuitry via the physical layer interface.

20. An apparatus, comprising:
a channel circuitry, that includes a disk manager module, that is operable to perform a first plurality of operations that includes:
error correction encoding of first information that is written to a disk within a hard disk drive; and
error correction decoding of second information that is read from the disk within the hard drive;
a controller circuitry that is operable to perform a second plurality of operations that includes operations corresponding to host interfacing; and
a physical layer interface that couples the channel circuitry and the controller circuitry and that is operable to support direct memory access (DMA) protocol data transfers and DMA control between the channel circuitry and the controller circuitry; and wherein:
the physical layer interface that couples the channel circuitry and the controller circuitry is a first interface type; and
a disk interface through which the channel circuitry communicates to the disk for read and write access is a second interface type.
